(19) United States
(12) Patent Application Publication
(10) Pub. No.: US 2005/0241538 A1
(43) Pub. Date: Nov. 3, 2005

(54) Methods of making cement compositions using liquid additives containing lightweight beads

(76) Inventors: Richard F. Vargo JR., Katy, TX (US); David S. Kulakofsky, Katy, TX (US)

Correspondence Address: CRAIG W. RODDY;HALLIBURTON ENERGY SERVICES, P.O. BOX 1431, DUNCAN, OK, 73536-0440, US

(21) Appl. No.: 10/833,616

(22) Filed: Apr. 28, 2004

(51) Int. Cl. C04B 14/04

(52) U.S. Cl. 106/713

(57) ABSTRACT

Methods of making a cement composition include combining a liquid additive comprising lightweight beads and fluid with a cement, wherein the liquid additive is substantially absent of a water absorbing material. The liquid additive may further comprise a dispersant. A mass ratio of the fluid to the lightweight beads in the liquid additive may be less than or equal to about 1:1. The liquid additive may be introduced to a delivery pump that supplies water to a cement mixing head for producing a cement slurry. Alternatively, the liquid additive may be introduced to a cement slurry as the slurry is being pumped into a wellbore. Systems for transporting the liquid additive include a recirculating pump for moving the liquid additive from the bottom of a vessel to the top of the vessel, thereby causing floating beads to be mixed down in the liquid additive.

### FIELD OF THE INVENTION

The present invention generally relates to methods of making cement compositions, and more particularly to liquid additives containing lightweight beads and methods of making cement compositions from such liquid additives and of transporting the liquid additives to near a wellbore where such cement compositions are made.

### BACKGROUND OF THE INVENTION

Well cementing is a process used in penetrating subterranean formations to recover subterranean resources such as gas, oil, minerals, and water. In well cementing, a well bore is drilled while a drilling fluid is circulated through the well bore. After the drilling is terminated, a string of pipe, e.g., casing, is run in the well bore. Primary cementing is then typically performed whereby a cement slurry is pumped down through the string of pipe and into the annulus between the string of pipe and the walls of the wellbore to allow the cement slurry to set into a hard mass and thereby seal the annulus. Subsequent secondary cementing operations may also be performed. One example of a secondary cementing operation is squeeze cementing whereby a cement slurry is forced under pressure to areas of lost integrity in the annulus to seal off those areas.

Low density or lightweight cement compositions are commonly used in wells that extend through weak subterranean formations to reduce the hydrostatic pressure exerted by the cement column on the weak formation, which otherwise might undesirably fracture or damage the formation. Conventional lightweight cement compositions are made by adding more water to reduce the slurry density. Unfortunately, the addition of more water typically increases the cure time and reduces the strength of the resulting cement column. Lightweight cement compositions containing lightweight beads have been developed as a better alternative to cement compositions containing large quantities of water. The lightweight beads reduce the density of the cement composition such that less water is required to form the cement composition.

The lightweight beads are typically combined with a dry bulk mixture of cement before transporting the resulting dry blend in a bulk container such as a tank to an onsite location near where its use is intended. The dry blend can then be mixed with water to form a slurry when it is desirable to seal a wellbore. Forming a dry blend of the cement and the lightweight beads in this manner leads to several problems. First, the beads may segregate within the dry blend during blending, loading, unloading, and transporting. Such segregation may be caused by the variation in the specific gravity of the lightweight beads and the density of the cement. Special procedures are often employed to reduce the segregation of the beads. For example, an expensive blending system may be used in an attempt to blend the beads and the cement more thoroughly. Also, sample catchers may be installed on the tank for taking samples of the dry blend to determine whether the beads are evenly distributed in the blend. Following such procedures not only complicates matters but also can be very costly. In addition, a portion of the cement commonly passes out of the tank through its vent system during transport of the blend, resulting in the loss of the blend to a waste system. This loss is a direct expense to the end user of the blending system.

Another problem associated with pre-mixing the cement with the lightweight beads is the difficulty in meeting the design specification of the cement to water ratio in the cement slurry being delivered downhole. In particular, the rate at which the dry blend of cement and beads is combined with the water may be hard to control and may require the utilization of a volumetric mixing system.

A need therefore exists for a simpler, more cost effective method of preparing a cement composition comprising lightweight beads. Further, it is desirable to form the cement composition in a manner that ensures its properties will meet their design specifications.

### SUMMARY OF THE INVENTION

In an embodiment, methods of making a cement composition include combining a liquid additive comprising lightweight beads and fluid with a cement, wherein the liquid additive is substantially absent of a water absorbing material. The liquid additive may further comprise other types of additives such as a dispersant. In another embodiment, methods of making a cement composition include: (a) preparing a liquid additive by selecting a volume of the lightweight beads which are separated by a volume of void space and combining the lightweight beads with a volume of fluid ranging from about equal to the volume of the void space to about 30% greater than the volume of the void space; and (b) combining the liquid additive with a cement. In yet another embodiment, a cement composition is made by combining a liquid additive comprising lightweight beads and fluid with a cement, wherein a mass ratio of the fluid to the lightweight beads in the liquid additive is less than or equal to about 1:1.

In an embodiment, methods of producing a cement composition include transporting a liquid additive comprising lightweight beads and fluid in a vessel to a location near a wellbore while circulating the liquid additive from the bottom of the vessel to the top of the vessel, followed by combining the liquid additive with the cement. In another embodiment, methods of producing a cement composition include combining a liquid additive comprising lightweight beads and fluid with additional water to form a diluted liquid additive, and combining the diluted liquid additive with cement to form a cement slurry. In an alternative embodiment, the cement composition is produced by combining a liquid additive comprising lightweight beads and fluid with a cement slurry as the slurry is being pumped into a wellbore.

In an embodiment, methods of making a liquid additive for a cement composition include selecting a volume of the lightweight beads which contain a volume of void space and combining the lightweight beads with a volume of fluid ranging from about equal to the volume of the void space to about 30% greater than the volume of the void space. Liquid additives made by such methods are also contemplated. In another embodiment, liquid additives for a cement composition include fluid and lightweight beads but are substantially absent of a water absorbing material. In yet another embodiment, liquid additives for a cement composition include fluid and lightweight beads, wherein a mass ratio of the water to the lightweight beads is less than or equal to about 1:1.

According to an embodiment, systems for transporting a liquid additive for a cement composition comprise a vessel for holding the liquid additive, a conduit extending from a bottom of the vessel to near a top of the vessel and a recirculating pump disposed in the conduit for moving the liquid additive from the bottom to the top of the vessel. Such systems may also include a drain located near the bottom of the vessel and attached to the conduit for allowing the liquid additive to flow out of the vessel. The systems may further include a hopper attached to the top of the vessel and to the conduit for receiving the liquid additive and directing it into the vessel. In another embodiment, systems are provided for transporting a liquid additive for a cement composition, wherein the liquid additive comprises a liquid and lightweight beads having a specific gravity of less than or equal to about a specific gravity of the liquid. The systems are capable of causing the lightweight beads to be substantially dispersed throughout the liquid.

### BRIEF DESCRIPTION OF THE DRAWINGS

FIG. 1 depicts a side plan view of a system for transporting a liquid additive to an on-site location where it may be combined with a cement to form a cement slurry.

### DETAILED DESCRIPTION OF THE PREFERRED EMBODIMENTS

Liquid additives comprising lightweight beads and fluid can be used to make cement compositions for isolating wellbores. As used herein, “lightweight bead” is defined as a particle that can be combined with a cement composition to lower its density, wherein the particle may be solid or hollow and is preferably a spherical, hollow object filled with gas. Examples of suitable lightweight beads include cenospheres, glass spheres, ceramic spheres, and combinations thereof. For example, the lightweight beads present in the liquid additive may comprise HGS 4,000 microspheres, HGS 10,000 microspheres, HGS 18,000, or combinations thereof, wherein the HGS microspheres are commercially available from 3M Company. The lightweight beads usually have a specific gravity less than that of the fluid and thus float in the fluid. However, some types of lightweight beads such as solid beads may have a specific gravity about equal to that of the carrier fluid.

The fluid contained in the liquid additives may include, for example, fresh water and/or salt water such as an unsaturated aqueous salt solution or a saturated aqueous salt solution, e.g., brine or seawater. It may further include additional materials as deemed appropriate by one skilled in the art. Examples of such materials include but are not limited to typical cement additives such as dispersants, cement friction reducers, fluid loss control additives, set retarding agents, set accelerating agents, strength retrogression control agents, viscosifying agents, and formation conditioning agents.

The liquid additives may be prepared by combining an effective amount of fluid with the lightweight beads to suspend the beads therein, followed by blending the beads and the fluid until the beads are distributed throughout the fluid. By way of example, the lightweight beads and the fluid may be blended using a blender, a mixer, a stirrer, a jet mixing system, or a similar device known in the art. In an embodiment, the fluid comprises water, and at least one dispersant is blended with the lightweight beads and the water to reduce the volume of water required to suspend the beads. An example of a suitable dispersant is CFR-3 dispersant, which is commercially available from Halliburton, Inc. The concentration of the dispersant in the ensuing cement composition may be determined based on the desired slurry properties in accordance with conventional design techniques. In an embodiment, the amount of the dispersant added may be selected such that its concentration in the ensuing cement composition is in a range of from about 0.03 gallon/sack of cement (gal/sk) to about 0.30 gal/sk. In an alternative embodiment, the dispersant may already be present in the fluid comprising water before the fluid is blended with the lightweight beads. In another embodiment, the fluid comprises water, and at least one cement friction reducer is blended with the lightweight beads and the water. In an alternative embodiment, the friction reducer may already be present in the fluid comprising water before the fluid is blended with the lightweight beads.

The amount of water present in the liquid additives is desirably minimized to decrease the load capacity required to transport the liquid additives (or alternatively to increase the amount of lightweight beads that can be transported by a given load capacity) and thereby lower the cost of transporting the liquid additives. As such, the liquid additives preferably are “substantially absent” of water absorbing materials, meaning that they do not contain water absorbing materials that could undesirably increase the amount of water required to suspend the lightweight beads. Examples of such undesirable water absorbing materials include water swellable clays such as sodium bentonite, attapulgite, kalinite, meta-kaolinite, hectorite, or sepeolite and swellable crosslinked polymers that have the ability to absorb and store aqueous liquids by forming a gel, such as sodium acrylate-based polymers. Otherwise, additional water would be required in the liquid additives to account for such loss of water by absorption. For example, the volume of water and any other materials present in the liquid additives may range from about equal to a volume of void space that separates a pre-selected volume of beads to about 30% greater than the volume of void space. The pre-selected volume of lightweight beads may be based on a desired density of a cement composition from which the liquid additive is to be formed. In an embodiment, a mass ratio of the water to the lightweight beads in the liquid additive is less than or equal to about 1:1.

Cement compositions may be formed by transporting a liquid additive prepared in the manner described above in a vessel or tank to an on-site location near where a wellbore is located. Then neat cement previously transported to and, if necessary, stored at the on-site location may be combined with the liquid additive and with additional water and optional other additives to form the cement compositions. Separately transporting the dry cement and a liquid additive comprising the lightweight beads avoids the problems associated with transporting a dry blend of the cement and the beads. For example, there is no need to be concerned that a portion of the cement could be lost in the transport, for the amount of cement required to form the slurry can be measured on-site. The cement can be stored on-site in the form of neat cement. As such, any excess cement not used in forming the slurry can be used in subsequent operations. Further, the difficulty and costly procedures required to prevent the migration of the beads in the cement are no longer required.

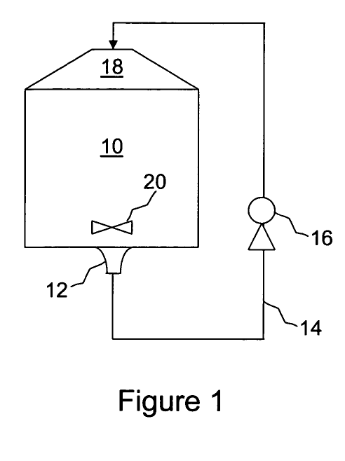

The liquid additive may be transported to the on-site location using a system that is capable of causing the lightweight beads, which naturally float to the top of the liquid additive, to be substantially dispersed throughout the liquid additive. In one embodiment, the system circulates liquid additive from the bottom of the vessel to near the top of the vessel, thereby forcing the floating lightweight beads toward the bottom of the vessel such that the water and the beads are continuously mixed. As shown in FIG. 1, this system may include a vessel 10 for holding the liquid additive, wherein the vessel 10 has a drain 12 near its base through which the liquid additive can pass out of the vessel 10. It further includes a conduit 14, e.g., a pipe, connected to the drain 12 that extends back to near the top of the vessel 10 for delivering the liquid additive there. A recirculating pump 16 may be disposed in the conduit 14 for conveying the liquid additive from the bottom of the vessel 10 to the top of the vessel 10. A hopper 18 may be connected to the top of the vessel 10 and the conduit 14 for receiving the liquid additive and directing it into the vessel 10. In an embodiment, the liquid additive is transported in a vessel that includes an internal agitation device. For example, a stirrer 20 may be placed in the vessel 10 shown in FIG. 1. In yet another embodiment, the liquid additive is transported in a vessel that is agitated via external means. For example, an external centrifugal pump may be attached to the vessel for circulating the liquid additive in the vessel.

The liquid additive may be combined with cement, additional water, and optional additional additives at the on-site location to form a cement composition or slurry when it is desirable to pump the slurry into a wellbore that penetrates a subterranean formation. The cement slurry is pumped down a conduit, e.g., a casing or a drill pipe, run in the wellbore and up into the annulus where it is allowed to set, thereby forming a substantially impermeable cement column that isolates the wellbore. In an embodiment, the concentration of the liquid additive in the cement composition is in a range of from about 0.5 gal/sk to about 3 gal/sk.

The cement may comprise hydraulic cement, which sets and hardens by reaction with water and is typically composed of calcium, aluminum, silicon, oxygen, sulfur, or combinations thereof. Examples of hydraulic cements are Portland cements, pozzolan cements, gypsum cements, high alumina content cements, silica cements, and high alkalinity cements. IN an embodiment, the cement is a Portland cement such as a class A, C, G, or H Portland cement or a TXI lightweight oil/well cement commercially available from Texas Industries Inc. of Dallas, Tex. The additional water may comprise fresh water, salt water such as an unsaturated aqueous salt solution or a saturated aqueous salt solution, or combinations thereof. Optional additional additives may be included in the cement compositions as deemed appropriate by those of skill in the art, including but not limited to set retarders, fluid loss control additives, defoamers, dispersing agents, set accelerators, and formation conditioning agents.

In an embodiment, the liquid additive is mixed with the additional water to form a diluted liquid additive, which is subsequently combined with the cement. For example, the liquid additive may be injected into a delivery pump being used to supply the additional water to a cement mixing head for mixing the additional water with the cement. As such, the water used to carry the lightweight beads and this additional water are both available to slurry the cement, and the lightweight beads become dispersed throughout the cement slurry. In an alternative embodiment, the liquid additive is combined with a previously mixed cement slurry as the slurry is being pumped into the wellbore. In both embodiments, the liquid additive may be injected into the suction of the pump. In both embodiments, the liquid additive can be added at a controlled rate to the water or the cement slurry using a continuous metering system (CMS) unit known in the art. The CMS unit can also be employed to control the rate at which the additional water is introduced to the cement as well as the rate at which any other optional additives are introduced to the cement slurry or the water. As such, the CMS unit can be used to achieve an accurate and precise ratio of water to cement and bead concentration in the cement slurry such that the properties of the slurry, e.g., its density, meet design specifications based on downhole conditions. Those design specifications may be determined before pumping the cement slurry downhole. In an embodiment, the volume of lightweight beads present in a cement slurry having a density of from about 11 to about 14.5 pounds per gallon is less than about 20% by volume of the cement slurry, alternatively less than about 10%.

### EXAMPLE

The invention having been generally described, the following example is given as particular embodiments of the invention and to demonstrate the practices and advantages hereof. It is understood that the example are given by way of illustration and is not intended to limit the specification or the claims to follow in any manner.

Eight tests were performed in which 58.8 grams of HGS-10,000 microspheres and 11.7 grams of CFR-3L dispersant were added to different amounts of water to form eight samples in 250 mL graduated cylinders. The eight samples were mixed by placing the dispersant in a beaker and then adding various concentrations of water. Next, the microspheres were added to the resulting mixture by stirring and then folding them into the mixture. The consistency of each sample was observed when it was initially mixed and after waiting for about 6 hours. The amount of water in each sample and the results of these observations are shown below in Table 1. These samples did not stick to the glass when mixed even when they became thick. Sample No. 7 was mixed again after waiting 20 days. It still re-associated very well and appeared to have no change in color when first mixed.

TABLE 1

| | Amount | Amount of | Amount of | |
|---|---|---|---|---|
| Sample | of Water, | HGS-10000 | CFR-3L | |
| No. | g | Microspheres, g | dispersant, g | Observations |
| 1 | 100 | 58.8 | 11.7 | Slurry was thin and did not |
| | | | | stick to the glass |
| 2 | 90 | 58.8 | 11.7 | Slurry was thin and did not |
| | | | | stick to the glass |
| 3 | 80 | 58.8 | 11.7 | Slurry was thin and did not |
| | | | | stick to the glass |
| 4 | 70 | 58.8 | 11.7 | Slurry was thin and did not |
| | | | | stick to the glass |
| 5 | 60 | 58.8 | 11.7 | Slurry was thicker but still did |
| | | | | not stick to the glass |
| 6 | 50 | 58.8 | 11.7 | Slurry was too thick but stuck |
| | | | | to the glass only a little |
| 7 | 55 | 58.8 | 11.7 | Slurry was thicker but still did |
| | | | | not stick to the glass |
| 8 | 58.8 | 58.8 | 11.7 | Slurry was thicker but still did |
| | | | | not stick to the glass. |

While the preferred embodiments of the invention have been shown and described, modifications thereof can be made by one skilled in the art without departing from the spirit and teachings of the invention. The embodiments described herein are exemplary only, and are not intended to be limiting. Many variations and modifications of the invention disclosed herein are possible and are within the scope of the invention. Use of the term “optionally” with respect to any element of a claim is intended to mean that the subject element is required, or alternatively, is not required. Both alternatives are intended to be within the scope of the claims.

Accordingly, the scope of protection is not limited by the description set out above but is only limited by the claims which follow, that scope including all equivalents of the subject matter of the claims. Each and every claim is incorporated into the specification as an embodiment of the present invention. Thus, the claims are a further description and are an addition to the preferred embodiments of the present invention. The discussion of a reference herein is not an admission that it is prior art to the present invention, especially any reference that may have a publication date after the priority date of this application. The disclosures of all patents, patent applications, and publications cited herein are hereby incorporated by reference, to the extent that they provide exemplary, procedural, or other details supplementary to those set forth herein.

1. A method of making a cement composition, comprising: combining a liquid additive comprising lightweight beads and fluid with a cement, wherein the liquid additive is substantially absent of a water absorbing material.

2. The method of claim 1, wherein the fluid comprises water.

3. The method of claim 1, wherein the water absorbing material comprises a water swellable clay, a swellable crosslinked polymer capable of absorbing and storing water by forming a gel, or combinations thereof.

4. The method of claim 3, wherein the water swellable clay comprises sodium bentonite, attapulgite, kalinite, meta-kaolinite, hectorite, sepeolite, a sodium acrylate-based polymer, or combinations thereof.

5. The method of claim 1, wherein the liquid additive further comprises a dispersant, a cement friction reducer, or combinations thereof.

6. The method of claim 1, wherein the liquid additive is made by a method comprising: (a) selecting a volume of the lightweight beads which are separated by a volume of void space; and (b) combining the lightweight beads with a volume of the fluid ranging from about equal to the volume of the void space to about 30% greater than the volume of the void space.

7. The method of claim 1, wherein a mass ratio of the fluid to the lightweight beads in the liquid additive is less than or equal to about 1:1.

8. The method of claim 1, wherein a concentration of the liquid additive in the cement composition is in a range of from about 0.5 gal/sk to about 3.0 gal/sk.

9. The method of claim 1, wherein the lightweight beads are substantially suspended in the liquid additive.

10. The method of claim 1, wherein the cement is stored in dry form near a wellbore.

11. The method of claim 1, further comprising transporting the liquid additive in a vessel to a location near a wellbore prior to said combining the liquid additive with the cement.

12. The method of claim 11, wherein the liquid additive is circulated from the bottom of the vessel to the top of the vessel while it is being transported.

13. The method of claim 11, wherein the liquid additive is agitated while it is being transported.

14. The method of claim 1, wherein said combining the liquid additive with the cement comprises adding the liquid additive to additional water before combining the additional water with the cement to from a cement slurry.

15. The method of claim 14, wherein the liquid additive is added to the additional water by injecting it into a delivery pump that supplies the additional water to a cement mixing head.

16. The method of claim 1, wherein said combining the liquid additive with the cement comprises adding the liquid additive to a slurry comprising the cement as the slurry is being pumped into a wellbore.

17. A method of making a cement composition, comprising:
(a) preparing a liquid additive by a method comprising: (i) selecting a volume of the lightweight beads which are separated by a volume of void space; and (ii) combining the lightweight beads with a volume of fluid ranging from about equal to the volume of the void space to about 30% greater than the volume of the void space; and
(b) combining the liquid additive with a cement.

18. The method of claim 17, wherein the fluid comprises water.

19. The method of claim 17, wherein the liquid additive further comprises a dispersant, a cement friction reducer, or combinations thereof.

20. The method of claim 17, wherein a mass ratio of the fluid to the lightweight beads in the liquid additive is less than or equal to about 1:1.

21. The method of claim 17, wherein a concentration of the liquid additive in the cement composition is in a range of from about 0.5 gal/sk to about 3.0 gal/sk.

22. The method of claim 17, wherein the lightweight beads are substantially suspended in the liquid additive.

23. The method of claim 17, wherein the cement is stored in dry form near a wellbore.

24. The method of claim 17, further comprising transporting the liquid additive in a vessel to a location near a wellbore prior to said combining the liquid additive with the cement.

25. The method of claim 24, wherein the liquid additive is circulated from the bottom of the vessel to the top of the vessel while it is being transported.

26. The method of claim 24, wherein the liquid additive is agitated while it is being transported.

27. The method of claim 17, wherein said combining the liquid additive with the cement comprises adding the liquid additive to additional water before combining the additional water with the cement to form a cement slurry.

28. The method of claim 27, wherein the liquid additive is added to the additional water by injecting it into a delivery pump that supplies the additional water to a cement mixing head.

29. The method of claim 17, wherein said combining the liquid additive with the cement comprises adding the liquid additive to a slurry comprising the cement as it is being circulated into a wellbore.

30. A method of making a cement composition, comprising: combining a liquid additive comprising lightweight beads and fluid with additional water before combining the additional water with the cement to form a cement slurry.

31. The method of claim 30, wherein the fluid comprises water.

32. The method of claim 30, wherein the liquid additive is added to the additional water by injecting it into a delivery pump that supplies the additional water to a cement mixing head.

33. The method of claim 30, wherein the liquid additive further comprises a dispersant, a cement friction reducer, or combinations thereof.

34. The method of claim 30, wherein a mass ratio of the fluid to the lightweight beads in the liquid additive is less than or equal to about 1:1.

35. The method of claim 30, wherein a concentration of the liquid additive in the cement composition is in a range of from about 0.5 gal/sk to about 3.0 gal/sk.

36. The method of claim 30, wherein the lightweight beads are substantially suspended in the liquid additive.

37. The method of claim 30, wherein the cement is stored in dry form near a wellbore.

38. The method of claim 30, further comprising transporting the liquid additive in a vessel to a location near a wellbore prior to said combining the liquid additive with the cement.

39. The method of claim 38, wherein the liquid additive is circulated from the bottom of the vessel to the top of the vessel while it is being transported.

40. The method of claim 38, wherein the liquid additive is agitated while it is being transported.

41. A method of making a cement composition, comprising: combining a liquid additive comprising lightweight beads and fluid with a cement slurry as the slurry is being pumped into a wellbore.

42. The method of claim 41, wherein the fluid comprises water.

43. The method of claim 41, wherein the liquid additive further comprises a dispersant, a cement friction reducer, or combinations thereof.

44. The method of claim 41, wherein a mass ratio of the water to the lightweight beads in the liquid additive is less than or equal to about 1:1.

45. The method of claim 41, wherein a concentration of the liquid additive in the cement composition is in a range of from about 0.5 gal/sk to about 3.0 gal/sk.

46. The method of claim 41, wherein the lightweight beads are substantially suspended in the liquid additive.

47. The method of claim 41, wherein the cement is stored in dry form near a wellbore.

48. The method of claim 41, further comprising transporting the liquid additive in a vessel to a location near a wellbore prior to said combining the liquid additive with the cement.

49. The method of claim 48, wherein the liquid additive is circulated from the bottom of the vessel to the top of the vessel while it is being transported.

50. The method of claim 48, wherein the liquid additive is agitated while it is being transported.

51. A method of making a cement composition, comprising:
(a) transporting a liquid additive comprising lightweight beads and fluid in a vessel to a location near a wellbore while circulating the liquid additive from the bottom of the vessel to the top of the vessel; and
(b) combining the liquid additive with the cement.

52. The method of claim 51, wherein the fluid comprises water.

53. The method of claim 51, wherein the liquid additive further comprises a dispersant, a cement friction reducer, or combinations thereof.

54. The method of claim 51, wherein a mass ratio of the fluid to the lightweight beads in the liquid additive is less than or equal to about 1:1.

55. The method of claim 51, wherein a concentration of the liquid additive in the cement composition is in a range of from about 0.5 gal/sk to about 3.0 gal/sk.

56. The method of claim 51, wherein the lightweight beads are substantially suspended in the liquid additive.

57. The method of claim 51, wherein the cement is stored in dry form near the wellbore.

58. A method of making a cement composition, comprising: combining a liquid additive comprising lightweight beads and fluid with a cement, wherein a mass ratio of the fluid to the lightweight beads in the liquid additive is less than or equal to about 1:1.

59. The method of claim 58, wherein the fluid comprises water.

60. The method of claim 58, wherein the liquid additive further comprises a dispersant a cement friction reducer, or combinations thereof.

61. The method of claim 58, wherein the lightweight beads are substantially suspended in the liquid additive.

62. The method of claim 58, wherein a concentration of the liquid additive in the cement composition is in a range of from about 0.5 gal/sk to about 3.0 gal/sk.

63. The method of claim 58, wherein the cement is stored in dry form near a wellbore.

64. The method of claim 58, further comprising transporting the liquid additive in a vessel to a location near a wellbore prior to said combining the liquid additive with the cement.

65. The method of claim 64, wherein the liquid additive is agitated while it is being transported.

66. An additive for a cement composition comprising fluid and lightweight beads, the additive being substantially absent of a water absorbing material.

67. The additive of claim 66, wherein the fluid comprises water.

68. The additive of claim 66, wherein the additive further comprises a dispersant, a cement friction reducer, or combinations thereof.

69. The additive of claim 66, wherein the liquid additive is made by a method comprising: (a) selecting a volume of the lightweight beads which are separated by a volume of void space; and (b) combining the lightweight beads with a volume of the fluid ranging from about equal to the volume of the void space to about 30% greater than the volume of the void space.

70. The additive of claim 66, wherein a mass ratio of the fluid to the lightweight beads in the liquid additive is less than or equal to about 1:1.

71. The additive of claim 66, wherein the lightweight beads are substantially suspended in the liquid additive.

72. An additive for a cement composition comprising fluid and lightweight beads, wherein a mass ratio of the fluid to the lightweight beads in the liquid additive is less than or equal to about 1:1.

73. The additive of claim 72, wherein the additive further comprises a dispersant, a cement friction reducer, or combinations thereof.

74. The additive of claim 72, wherein the lightweight beads are substantially suspended in the liquid additive.

75. A method of making a liquid additive for a cement composition, comprising:
(a) selecting a volume of the lightweight beads which are separated by a volume of void space; and
(b) combining the lightweight beads with a volume of fluid ranging from about equal to the volume of the void space to about 30% greater than the volume of the void space.

76. The method of claim 75, wherein the fluid comprises water.

77. A liquid additive made by the method of claim 75.

78. The method of claim 75, wherein a mass ratio of the fluid to the lightweight beads in the liquid additive is less than or equal to about 1:1.

79. A method of transporting a liquid additive for a cement composition, comprising: moving the liquid additive in a vessel while circulating the liquid additive from a bottom of the vessel to a top of the vessel, wherein the liquid additive comprises a liquid and lightweight beads.

80. The method of claim 79, wherein said circulating causes at least a portion of the lightweight beads floating near the top of the vessel to move toward the bottom of the vessel.

81. A system for transporting a liquid additive for a cement composition, comprising:
(a) a vessel for holding the liquid additive, which comprises lightweight beads and fluid;
(b) a conduit extending from a bottom of the vessel to near a top of the vessel; and
(c) a recirculating pump disposed in the conduit for continuously moving the liquid additive from the bottom to the top of the vessel.

82. The system of claim 81, further comprising a drain located near the bottom of the vessel for allowing the liquid additive to flow out of the vessel, wherein the conduit is attached to the drain.

83. The system of claim 81, further comprising a hopper attached to the top of the vessel and to the conduit for receiving the liquid additive and directing it into the vessel.

84. A system for transporting a liquid additive for a cement composition, the liquid additive comprising a liquid and lightweight beads having a specific gravity less than or equal to about a specific gravity of the liquid, wherein the system is capable of causing the lightweight beads to be substantially dispersed throughout the liquid.
